(19) United States
(12) Patent Application Publication
(10) Pub. No.: US 2023/0150458 A1
(43) Pub. Date: May 18, 2023

(54) BRAKE ASSEMBLY

(71) Applicant: Dana Italia S.r.l., Arco (IT)

(72) Inventors: Jarrett P. DAVIS, Whitehouse, OH (US); Gianluca TERRASI, Dro (IT); Idris POONAWALA, Maharashtra (IN)

(73) Assignee: Dana Italia S.r.l., Arco (IT)

(21) Appl. No.: 17/455,444

(22) Filed: Nov. 18, 2021

(51) Int. Cl. B60T 1/06; F16D 55/40; F16D 65/18

(52) U.S. Cl. CPC B60T 1/065; F16D 55/40; F16D 65/186; F16D 2127/02

(57) ABSTRACT

An axle assembly for a vehicle comprising an axle housing and a brake assembly coupled to the axle housing. In certain embodiments, the axle housing is configured to receive an interchangeable brake assembly. The brake assembly may comprise a housing having a first chamber and a second chamber, a brake mechanism and a first piston disposed in the first chamber, and a second piston disposed in the second chamber. The first piston may be configured to selectively activate the brake mechanism. The second piston may be disposed in the second chamber adjacent a biasing mechanism having at least one pre-compressed biasing element, wherein the second piston may be configured to selectively activate the brake mechanism.

### FIELD

The subject matter of the embodiments described herein relates generally to an axle assembly for a vehicle and, more particularly, to a brake assembly of the axle assembly for the vehicle.

### BACKGROUND

A vehicle including an axle assembly with a brake assembly is known in the art. The brake assembly may comprise a multi-disc brake or clutch designed to generate a constant braking or coupling force. Hydraulically actuated disc brakes are the most commonly used form of brake for motor vehicles due to their stable performance at higher speeds and resistance to brake fade.

However, the disc brakes are subjected to extreme conditions and wear each time the vehicle is stopped. Accordingly, the brake assembly, including but not limited to the disc brakes, requires continued maintenance and repair to maintain performance of the axle assembly. Typically, an installation of the brake assembly into the axle assembly during production or the repair of the brake assembly is difficult, particularly when parts need to be pressed into an arm of the axle assembly using specialized equipment. Some brake assemblies require an expensive hydraulic pressing system to compress spring applied hydraulic release (SAHR) springs so the service brake assemblies can be installed and secured.

It would be desirable to produce a brake assembly for an axle assembly that improves manufacturability and quality of the brake assembly while minimizing cost and complexity thereof.

### SUMMARY

In concordance and agreement with the present disclosure, a brake assembly for an axle assembly that improves manufacturability and quality of the brake assembly while minimizing a cost and complexity thereof, has surprisingly been discovered.

In one embodiment, a brake assembly for an axle assembly, comprises: a brake mechanism including a plurality of brake discs; at least one biasing mechanism including at least one biasing element disposed adjacent the brake mechanism, wherein the at least one biasing element is pre-compressed; and a housing circumferentially enclosing at least a portion of the brake mechanism and at least a portion of the at least one biasing mechanism, wherein the housing is configured to mate with an axle housing of the axle assembly.

As aspects of certain embodiments, the brake mechanism is an interchangeable brake mechanism, and wherein a profile of the housing is configured to receive the interchangeable brake mechanism.

As aspects of certain embodiments, a profile of the housing is configured to receive differing numbers of the brake discs.

As aspects of certain embodiments, the brake assembly further comprises an end plate configured to be coupled to the housing of the brake assembly.

As aspects of certain embodiments, the end plate is configured to be coupled to the axle housing of the axle assembly.

As aspects of certain embodiments, an interior cavity of the housing is divided into a first chamber and a second chamber by a web portion.

As aspects of certain embodiments, the brake assembly further comprises a first piston disposed in a first chamber of the housing and a second piston disposed in a second chamber of the housing.

As aspects of certain embodiments, an activation of the first piston causes an activation of the brake assembly.

As aspects of certain embodiments, an activation of the second piston causes the at least one biasing element of the biasing mechanism to move to a compressed state.

As aspects of certain embodiments, a deactivation of the second piston results in the at least one biasing element of the biasing mechanism to move to an expanded state.

As aspects of certain embodiments, the biasing mechanism further includes a positioning element configured to maintain a position of the at least one biasing element, and wherein a portion of the positioning element surrounds an outer circumferential surface of the at least one biasing element.

As aspects of certain embodiments, the biasing mechanism further includes a retainer configured to maintain a position of the positioning element.

In another embodiment, an axle assembly, comprises: an axle housing; and a brake assembly coupled to the axle housing, the brake assembly comprises: a housing having a first chamber and a second chamber; a brake mechanism disposed in the first chamber; a first piston disposed in the first chamber, wherein the first piston is configured to selectively activate the brake mechanism; and a second piston disposed in the second chamber adjacent a biasing mechanism having at least one biasing element, wherein the second piston is configured to selectively activate the brake mechanism.

As aspects of certain embodiments, the brake assembly is removably received in and releasably coupled to an end of the axle housing.

As aspects of certain embodiments, the brake assembly is a cartridge style brake assembly that is preassembled prior to installation into the axle assembly.

As aspects of certain embodiments, the at least one biasing element is pre-compressed.

As aspects of certain embodiments, the brake assembly further includes a biasing mechanism disposed adjacent the brake mechanism in the first chamber.

As aspects of certain embodiments, at least one of the first chamber and second chamber includes an activation cavity in fluid communication with a source of pressurized fluid.

In yet another embodiment, an axle assembly, comprises: an axle housing configured to receive an interchangeable brake assembly, wherein the interchangeable brake assembly comprises: a housing having at least one chamber formed therein; a brake mechanism disposed in the at least one chamber; and at least one piston disposed in the at least one chamber, wherein the at least one piston is configured to selectively activate the brake mechanism.

As aspects of certain embodiments, the brake mechanism is an interchangeable brake mechanism.

### BRIEF DESCRIPTION OF THE DRAWINGS

The above, as well as other objects and advantages of the subject matter of the embodiments described herein, will become readily apparent to those skilled in the art from a reading of the following detailed description of the embodiments when considered in the light of the accompanying drawings in which:

FIG. 1 is a fragmentary cross-sectional view of a portion of an axle assembly including a wheel assembly and a brake assembly according to an embodiment of the subject disclosure;

FIG. 2 is a side perspective view, in section, of the brake assembly of FIG. 1;

FIG. 3 is a fragmentary side elevational view of the axle assembly shown in FIG. 1, wherein the wheel assembly has been removed;

FIG. 4 is a fragmentary cross-sectional view of a portion of an axle housing of the axle assembly shown in FIG. 1;

FIG. 5 is a cross-sectional view of the brake assembly of FIG. 1-3, wherein the brake assembly includes three brake discs and four separator plates;

FIG. 6 is a cross-sectional view of the brake assembly of FIG. 1-3, wherein the brake assembly includes two brake discs and three separator plates; and

FIG. 7 is a fragmentary cross-sectional view of a portion of an axle assembly including a brake assembly according to another embodiment of the subject disclosure.

### DETAILED DESCRIPTION

The following detailed description and appended drawings describe and illustrate various exemplary embodiments. The description and drawings serve to enable one skilled in the art to make and use the embodiments, and are not intended to limit the scope of the embodiments in any manner.

It is to be understood that the presently disclosed subject matter may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

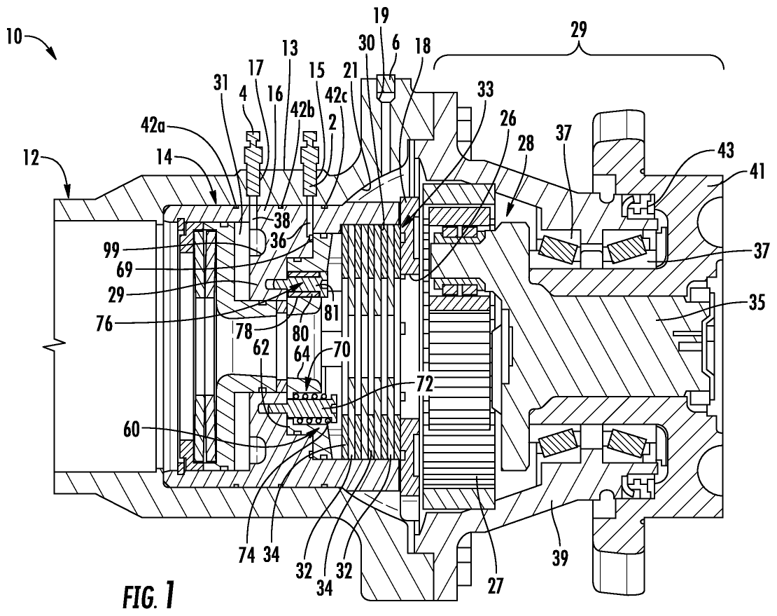

FIG. 1 shows a portion of an axle assembly 10 for a motor vehicle (not depicted) according to an embodiment of the presently disclosed subject matter. The vehicle may include a chassis or frame (not depicted) configured to support a pair of the axle assemblies 10. Each of the axle assemblies 10 may be configured to support a wheel (not depicted). It should be appreciated that at least one of the axle assemblies 10 may include one or more mechanisms (not depicted) for steering one or both of the axle assemblies 10. The vehicle may include a prime mover (not depicted) such as an internal combustion engine or an electric motor, for example, configure to power the vehicle and/or at least one of the axle assemblies 10. It is understood that the axle assemblies 10 may be any type of axle assembly as desired.

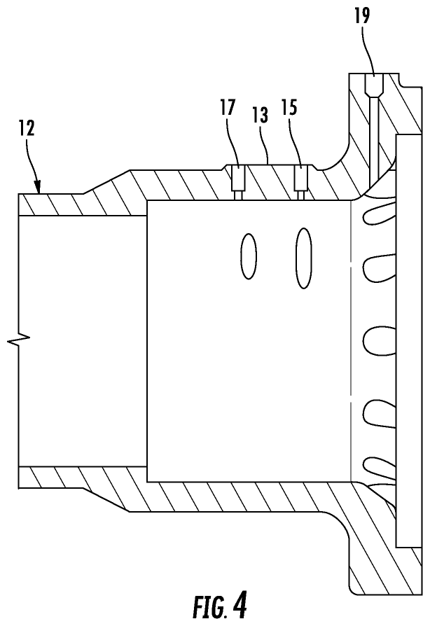

As illustrated, the axle assembly 10 may include an axle housing 12 having a brake assembly 14 at least partially disposed therein and a wheel assembly 29 coupled thereto. In certain embodiments, the brake assembly 14 is removably received in and releasably coupled to an end 13 of the axle housing 12 to allow the brake assembly 14 to be repaired and/or replaced. It should be appreciated that the brake assembly 14 may be coupled to the axle housing 12 by any method as desired such as by mechanical fasteners, for example. In certain embodiments, the brake assembly 14 may utilize pressurized fluid from a fluid source (not depicted) to actuate and/or de-actuate the brake assembly 14. A pump (not depicted) may be employed to cause the pressurized fluid from the fluid source to flow through at least one conduit (not depicted) to the braking assembly 14. As best seen in FIG. 4, the end 15 of the axle housing 12 may include a first port 15, a second port 17, and a third port 19. The ports 15, 17, 19 may be in fluid communication with the fluid source via the at least one conduit. In certain embodiments, each of the ports 15, 17 is an input port permitting a flow of the pressurized fluid from the fluid source into the axle housing 12 and the port 19 is a drain or output port permitting a flow of a depressurized fluid from the axle housing 12 back to the fluid source. Each of the ports 15, 17, 19 may further include a respective valve 2, 4, 6 to control the flow of the pressurized fluid to the brake assembly 14 and/or the flow of the depressurized fluid from the brake assembly 14.

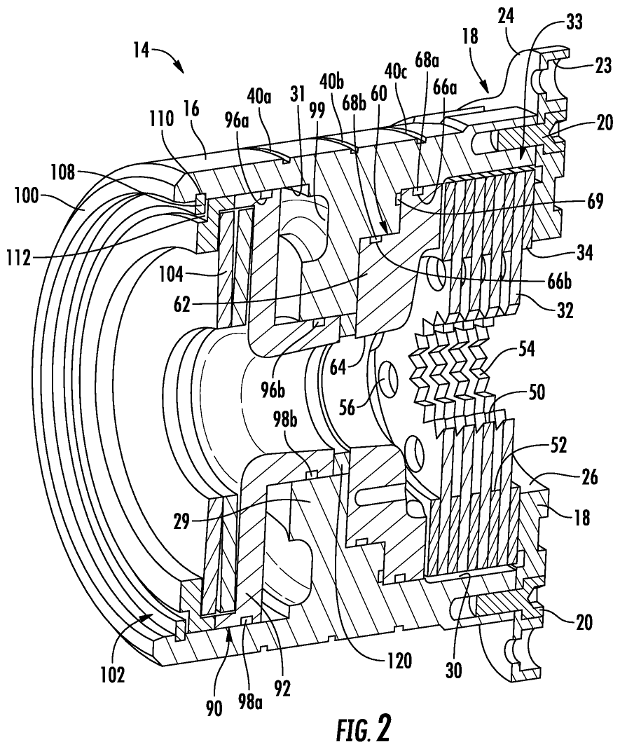

FIG. 2 shows a first embodiment of the brake assembly 14. The brake assembly 14 may be configured as a cartridge style brake assembly that may be pre-assembled prior to installation into the axle housing 12. The cartridge style brake assembly 14 permits installation to be simplified and circumvents potential undesirable effects of installing under high pressure conditions and a need for specialized equipment by an end user. The brake assembly 14 allows a manufacturer thereof to control an assembly process. Additionally, the brake assembly 14 may be an interchangeable brake assembly 14 at least partially received in the axle housing 12. In certain embodiments, the axle housing 12 may be a universal axle housing 12 having a profile configured to receive different configurations of the interchangeable brake assembly 14.

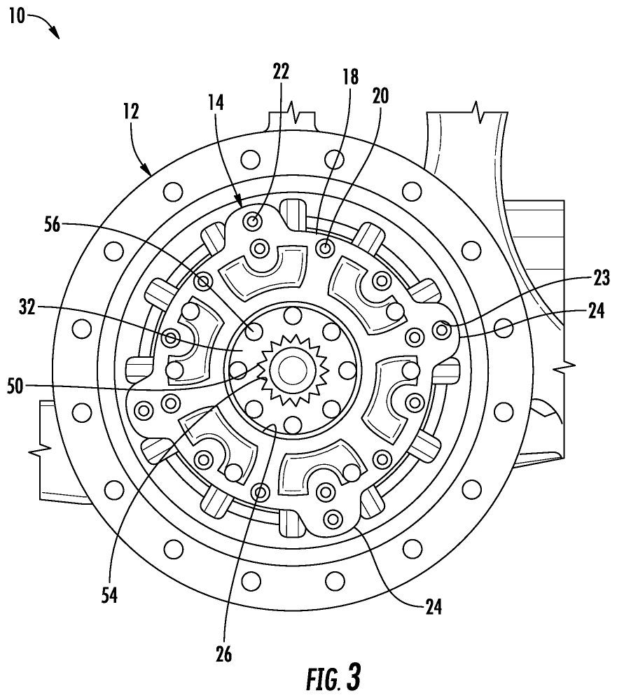

The brake assembly 14 may include an annular housing 16 and an end plate 18 configured to be coupled to the axle housing 12. Various methods may be employed to couple the end plate 18 to the annular housing 16 such as mechanical fasteners 20, for example. In certain embodiments, the annular housing 16 of the brake assembly 14 may be received in a cavity 21 formed in the axle housing 12. The end plate 18 may be secured to the axle housing 12 by a plurality of mechanical fasteners 22 to militate against an axial movement of the brake assembly 14 within the axle housing 12. It should be appreciated that the end plate 18 may be coupled to the axle housing 12 by any method as desired. As illustrated, the mechanical fasteners 22 may be received through bores 23 formed in an annular array of spaced apart ears 24 radially extending from the end plate 18. Although the end plate 18 shown includes four of the ears 24, it is understood that the end plate 18 may include more or less of the ears 24 than shown. The axle housing 12 may be configured to releasably receive the ears 24 of the end plate 18 to militate against a rotational movement of the brake assembly 14 within the axle housing 12. As best seen in FIG. 3, the end plate 18 may also include a central opening 26. In an embodiment, the central opening 26 may provide a journaling function for an axle shaft (not depicted) that connects the prime mover to a drive gear assembly 28 of the wheel assembly 29. As shown, the drive gear assembly 28 may include an output shaft 35 drivingly connected to an input shaft (e.g. the axle shaft) via a plurality of gears 27 disposed within a wheel housing 39 of the wheel assembly 29. The output shaft 35 may be rotatably supported within the wheel housing 39 by at least one bearing 37 disposed between the wheel housing 39 and a wheel hub 41. The wheel hub 41 may be configured to couple the output shaft 35 to the wheel of the vehicle. At least one seal 43 may be disposed between the wheel hub 41 and the wheel housing 39. It should be appreciated that other types of wheel assemblies may be employ for the wheel assembly 29 as desired.

As illustrated, the annular housing 16 of the brake assembly 14 may include a first conduit 36, a second conduit 38, and annular grooves 40a, 40b, 40c formed in an outer circumferential surface thereof. The grooves 40a, 40b, 40c may be formed in the outer circumferential surface on opposing sides of each of the conduits 36, 38. Seals 42a, 42b, 42c may be disposed in a respective one of the grooves 40a, 40b, 40c to form a substantially fluid tight seal between the axle housing 12 and the annular housing 16 of the brake assembly 14. In certain embodiments, an interior cavity of the annular housing 12 may be divided by an annular web portion 29 into an annular first chamber 30 and an annular second chamber 31. The first conduit 36 extends from the outer circumferential surface of the annular housing 16 of the brake assembly 14 to the first chamber 30. The second conduit 38 extends from the outer circumferential surface of the annular housing 16 of the brake assembly 14 to the second chamber 31. As best seen in FIG. 1, the first chamber 30 may be in fluid communication with the first port 15 via the first conduit 36 and the second chamber 31 may be in fluid communication with the second port 17 via the second conduit 38.

The annular housing 16 of the brake assembly 14 may provide a housing for a brake mechanism 33 comprising a plurality of brake discs 32 and at least one separator plate 34. In certain embodiments, the brake mechanism 33 may be an interchangeable brake mechanism 33 at least partially received in the annular housing 16. In certain embodiments, the annular housing 16 may be a universal annular housing 16 having a profile configured to receive different configurations of the interchangeable brake mechanism 33. The profile of the annular housing 16 of the brake assembly 14 may be configured to house various arrangements, configurations, sizes, shapes, and numbers of the brake discs 32 and the separator plates 34. Accordingly, the annular housing 16 of the brake assembly 14 allows the interchangeable brake mechanism 33 having various brake discs 32 and/or separator plates 34 to be employed to meet different requirements of the end user while maintaining the profile of the annular housing 16. It is understood that at least one of the brake discs 32 and the at least one separator plate 34 may be hardened so as to create an integral wear surface or have a coating deposited thereon to form the wear surface.

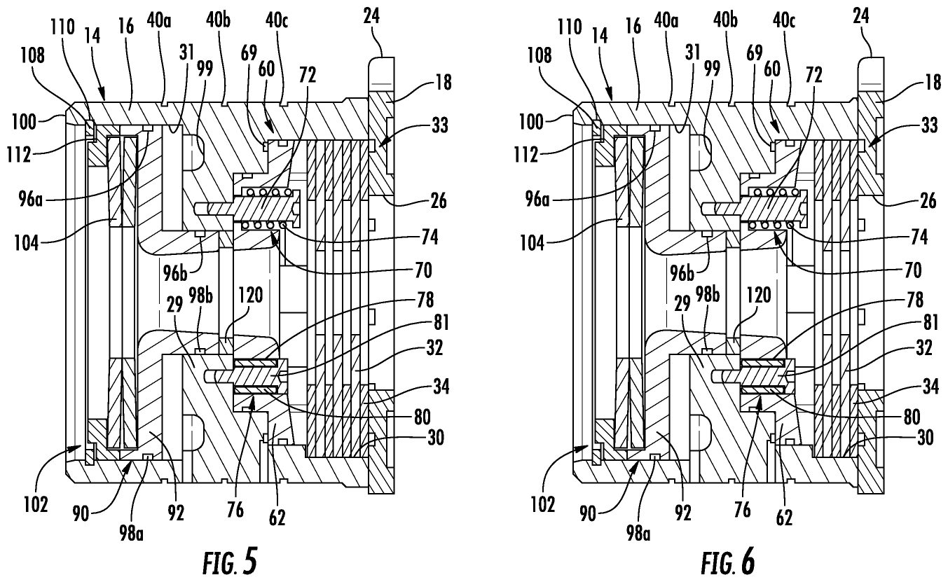

As more clearly shown in FIG. 1, the brake discs 32 and the at least on separator plate 34 are arranged within the first chamber 30 of the annular housing 12 in an alternating series. In the embodiment of FIG. 1, the brake assembly 14 includes four of the brake discs 32 in an alternating arrangement with five of the separator plates 34. In other embodiments shown in FIG. 5, the brake assembly 14 includes three of the brake discs 32 in an alternating arrangement with four of the separator plates 34. In yet other embodiments shown in FIG. 6, the brake assembly 14 includes two of the brake discs 32 in an alternating arrangement with three of the separator plates 34. It is understood that the brake assembly 14 may include more or less of the brake discs 32 and/or the separator plates 34 than shown if desired.

As illustrated, the at least one separator plate 34 may be keyed to the annular housing 16 of the brake assembly. In certain embodiments, the at least one separator plate 34 includes a plurality of protuberances (not depicted) (e.g. splines, teeth, etc.) formed on an outer circumferential surface thereof. The protuberances of the at least one separator plate 34 may be configured to be in meshed engagement with a plurality of protuberances (not depicted) (e.g. splines, teeth, etc.) formed on an inner circumferential surface of the annular housing 16 to militate against a rotational movement between the at least one separator plate 34 and the annular housing 16 while permitting an axial movement thereof.

Each of the brake discs 32 and the at least one separator plate 34 may include a respective one of central openings 50, 52. The central openings 50, 52 may provide a journaling function for the axle shaft. In certain embodiments, each of the brake discs 32 includes a plurality of protuberances 54 (e.g. splines, teeth, etc.) formed on an inner circumferential surface of the central openings 50. The protuberances 54 of the brake discs 32 may be configured to be in meshed engagement with a plurality of protuberances (not depicted) (e.g. splines, teeth, etc.) formed on an outer circumferential surface of the axle shaft to militate against a rotational movement between the brake discs 32 and the axle shaft while permitting an axial movement thereof. Additionally, the brake discs 32 and/or the at least one separator plate 34 may include an annular array of apertures 56 formed therein to permit a flow of the fluid or a lubricant therethrough.

A first piston 60 may be disposed in the first chamber 30 adjacent the brake discs 32 and separator plates 34 opposite the end plate 18. In certain embodiments, the first piston 60 may be an annular member 62 having a center bore 64 configured to receive the axle shaft therethrough. As illustrated, the annular member 62 of the first piston 60 may include annular grooves 66a, 66b formed in an outer circumferential surface thereof. The grooves 66a, 66b may be formed in the outer circumferential surface on opposing sides of the first conduit 36. Seals 68a, 68b may be disposed in a respective one of the grooves 66a, 66b to form a substantially fluid tight seal between the annular housing 16 and the first piston 60. Accordingly, a pressure in an activation cavity 69 formed between the first piston 60 and the annular housing 16 may be maintained and/or increased for activation of the first piston 60. An injection of the pressured fluid into the activation cavity 69 causes the first piston 60 to move in a first axial direction from a disengaged first position towards the brake mechanism 33 to an engaged second position.

A biasing mechanism 70 may be disposed in the first piston 60 and secured to the annular housing 16 of the brake assembly 14. In certain embodiments, the biasing mechanism 70 may include a pin member 72 fixedly attached to the web portion 29 of the annular housing 16 and a biasing element 74 (e.g. a helical spring) interposed between the pin member 72 and a portion of the first piston 60. The biasing mechanism 70 may provide uniform biasing of the first piston 60 causing the first piston 60 to move in a second axial direction from the engaged second position towards the web portion 29 of the annular housing 16 to the disengaged first position.

When the first piston 60 is deactivated by ceasing the flow of the pressurized fluid to the activation cavity 69, the first piston 60 is in the first position and the brake mechanism 33 is thereby disengaged having the brake discs 32 and the at least one separator plate 34 in an expanded state. In the expanded state, the brake discs 34 in meshed engagement with the axle shaft are permitted to rotate within the brake assembly 14 and the axle assembly to be driven. On the contrary, when the first piston 60 is activated by supplying the flow of the pressurized fluid to the activation cavity 69, the first piston 60 is caused to be in the second position and the brake mechanism 33 is thereby engaged having the brake discs 32 and the at least one separator plate 34 in a compressed state. In the compressed state, frictional forces between the brake discs 34 and the at least one separator plate 34 causes a rotation of the brake discs 32 and the axle shaft in meshed engagement therewith to cease and the axle assembly to be stopped.

In certain embodiments, the first piston 60 may further include a valve 76 disposed through a bore 78 into the annular housing 16 of the brake assembly 14. In certain embodiments, the valve 76 may include a housing 80 disposed in the bore 78 and a pin member 81 disposed through the housing 80 into the web portion 29 of the annular housing 16 of the brake assembly 14. The valve 76 may provide a relief passageway for the fluid and/or lubricant located between the first piston 60 and the web portion 29 of the annular housing 16 when the first piston 60 moves in the second axial direction from the engaged second position back to the disengaged first position.

A second piston 90 may be disposed in the second chamber 31 adjacent the web portion 29 of the annular housing 16 of the brake assembly 14. In certain embodiments, the second piston 90 may be an annular member 92 having a center bore 94 configured to receive the axle shaft therethrough. As illustrated, the annular member 92 of the second piston 90 may include annular grooves 96a, 96b formed in an outer circumferential surface thereof. The grooves 96a, 96b may be formed in the outer circumferential surface on opposing sides of the second conduit 38. Seals 98a, 98b may be disposed in a respective one of the grooves 96a, 96b to form a substantially fluid tight seal between the annular housing 16 and the second piston 90. Accordingly, a pressure in an activation cavity 99 formed between the second piston 90 and the annular housing 16 may be maintained and/or increased for activation of the second piston 90. An injection of the pressured fluid into the activation cavity 99 causes the second piston 90 to move in the second axial direction from a first position adjacent the web portion 29 towards an open end 100 of the annular housing 16 to a second position.

A biasing mechanism 102 may be disposed in the second chamber 31. In certain embodiments as best seen in FIG. 2, the biasing mechanism 102 may include at least one biasing element 104 (e.g. a disc spring, a wave spring, etc.) interposed between a portion of the second piston 90 and a positioning element 106. In certain embodiments, the at least one biasing element 104 is pre-compressed during an installation into the annular housing 16 of the brake assembly 14. When the brake assembly 14 includes the at least one pre-compressed biasing element 104, the installation of the brake assembly 14 into the axle assembly 10 during production or the repair of the brake assembly 14 is simplified, particularly since specialized equipment to assemble the brake assembly 14 into the axle housing 12 of the axle assembly 10 is not necessary. The biasing mechanism 102 may provide uniform biasing of the second piston 90 causing the second piston 90 to move in the first axial direction from the second position adjacent the open end 100 of the annular housing 16 to the first position. As illustrated, the positioning element 106 may be generally ring-shaped having a central opening 108 formed therein. In an embodiment, the central opening 108 may provide a journaling function for the axle shaft. The positioning element 106 may be configured to maintain a position of an end or one side of the at least one biasing element 104 during operation of the second piston 90. In certain embodiments, a portion of the positioning element 106 may surround an outer circumferential surface of the at least one biasing element 104. A retainer 108 (e.g. a spring clip, circlip, snap ring, etc.) may be employed to maintain a position of the positioning element 106. In certain embodiment, the retainer 108 may be at least partially received in a groove 110 formed in the inner circumferential surface of the annular housing 16 and at least partially received in an annular recess 112 formed in a face of the positioning element 106 opposite the at least one biasing element 104. A ring-shaped collar 120 may be interposed between first piston 60 and the second piston 90.

When the second piston 90 is deactivated by ceasing the flow of the pressurized fluid to the activation cavity 99, the second piston 90 is urged by the biasing mechanism 102 into the first position or an expanded state, which causes the first piston 60 to be in the second position, and the brake mechanism 33 is thereby engaged having the brake discs 32 and the at least one separator plate 34 in a compressed state. In the compressed state, frictional forces between the brake discs 34 and the at least one separator plate 34 causes a rotation of the brake discs 32 and the axle shaft in meshed engagement therewith to cease and the axle assembly to be stopped. On the contrary when the second piston 90 is activated by supplying the flow of the pressurized fluid to the activation cavity 99, the second piston 60 is caused to be in the second position and the biasing mechanism 102 is moved into a second position or a compressed state. When the second piston 90 is in the second position, depending on activation of the first piston 60, the first piston 60 may be in either the first position with the brake mechanism 33 disengaged or the second position with the brake mechanism 33 engaged.

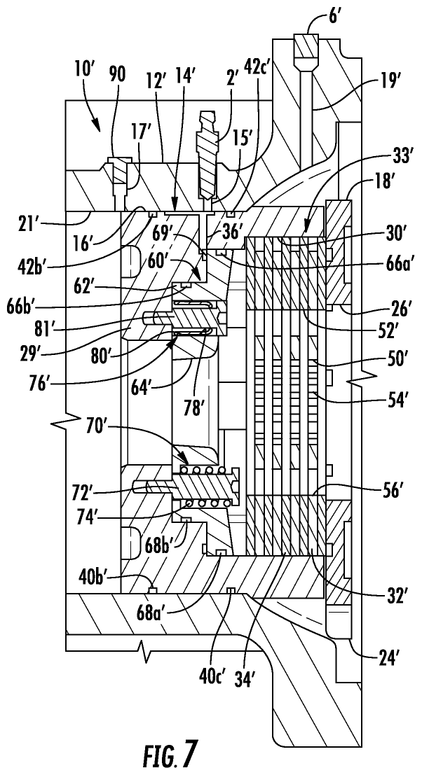

FIG. 7 shows another embodiment of a brake assembly 14′ of an axle assembly 10′ similar to that shown in FIGS. 1-6 without the second piston 90. Reference numerals for similar structure in respect of the description of FIGS. 1-6 are repeated in FIG. 7 with a prime (′) symbol.

The brake assembly 14′ may be configured as a cartridge style brake assembly that may be pre-assembled prior to installation into the axle housing 12′. The cartridge style brake assembly 14′ permits installation to be simplified and allows a manufacturer thereof to control an assembly process. Additionally, the brake assembly 14′ may be an interchangeable brake assembly 14′ at least partially received in the axle housing 12′. In certain embodiments, the axle housing 12′ may be a universal axle housing 12′ having a profile configured to receive different configurations of the interchangeable brake assembly 14′.

The brake assembly 14′ may include an annular housing 16′ and an end plate 18′ configured to be coupled to the axle housing 12′. Various methods may be employed to couple the end plate 18′ to the annular housing 16′ such as mechanical fasteners (not depicted), for example. In certain embodiments, the annular housing 16′ of the brake assembly 14′ may be received in a cavity 21′ formed in the axle housing 12′. The end plate 18′ may be secured to the axle housing 12′ by a plurality of mechanical fasteners (not depicted) to militate against an axial movement of the brake assembly 14′ within the axle housing 12′. It should be appreciated that the end plate 18′ may be coupled to the axle housing 12′ by any method as desired. As illustrated, the mechanical fasteners may be received through bores (not depicted) formed in an annular array of spaced apart ears 24′ radially extending from the end plate 18′. It is understood that the end plate 18′ may include any number of the ears 24′ as desired. The axle housing 12′ may be configured to releasably receive the ears 24′ of the end plate 18′ to militate against a rotational movement of the brake assembly 14′ within the axle housing 12′. The end plate 18′ may also include a central opening 26′. In an embodiment, the central opening 26′ may provide a journaling function for an axle shaft (not depicted) that connects the prime mover to a drive gear assembly (not depicted) of a wheel assembly (not depicted). As shown, the drive gear assembly may include an output shaft (not depicted) drivingly connected to an input shaft (e.g. the axle shaft) via a plurality of gears (not depicted) disposed within a wheel housing (not depicted) of the wheel assembly. The output shaft may be rotatably supported within the wheel housing by at least one bearing (not depicted) disposed between the wheel housing and a wheel hub (not depicted). The wheel hub may be configured to couple the output shaft to the wheel of the vehicle. At least one seal (not depicted) may be disposed between the wheel hub and the wheel housing. It should be appreciated that other types of wheel assemblies may be employ for the wheel assembly as desired.

As illustrated, the annular housing 16′ of the brake assembly 14′ may include a first conduit 36′ and annular grooves 40b′, 40c′ formed in an outer circumferential surface thereof. The grooves 40b′, 40c′ may be formed in the outer circumferential surface on opposing sides of the first conduit 36′. Seals 42b′, 42c′ may be disposed in a respective one of the grooves 40b′, 40c′ to form a substantially fluid tight seal between the axle housing 12′ and the annular housing 16′ of the brake assembly 14′. In certain embodiments, an interior cavity of the annular housing 12′ may be defined by an annular web portion 29′ forming an annular first chamber 30′. The first conduit 36′ extends from the outer circumferential surface of the annular housing 16′ of the brake assembly 14′ to the first chamber 30′. The first chamber 30′ may be in fluid communication with a first port 15′ via the first conduit 36′. In certain embodiments, the first port 15′ is an input port permitting a flow of the pressurized fluid from the fluid source into the axle housing 12′. In other embodiments, the universal axle housing 12′ may include a second port 17′ to accommodate other configurations of the brake assembly 14′. A third port 19′ may be formed in the axle housing 12′ as a drain or output port permitting a flow of a depressurized fluid from the axle housing 12′ back to the fluid source. Each of the ports 15′, 19′ may further include a respective valve 2′, 6′ to control the flow of the pressurized fluid to the brake assembly 14′ and/or the flow of the depressurized fluid from the brake assembly 14′. In embodiments where the axle housing 12′ includes the second port 17′, the second port 17′ may include a plug 90 disposed therein to militate against a flow of the fluid from the cavity 21′ of the axle housing 12′.

The annular housing 16′ of the brake assembly 14′ may provide a housing for a brake mechanism 33′ comprising a plurality of brake discs 32′ and at least one separator plate 34′. In certain embodiments, the brake mechanism 33′ may be an interchangeable brake mechanism 33′ at least partially received in the annular housing 16′. In certain embodiments, the annular housing 16′ may be a universal annular housing 16′ having a profile configured to receive different configurations of the interchangeable brake mechanism 33′. The profile of the annular housing 16′ of the brake assembly 14′ may be configured to house various arrangements, configurations, sizes, shapes, and numbers of the brake discs 32′ and the separator plates 34′. Accordingly, the annular housing 16′ of the brake assembly 14′ allows the interchangeable brake mechanism 33′ having various brake discs 32′ and/or separator plates 34′ to be employed to meet different requirements of the end user while maintaining the profile of the annular housing 16′. It is understood that at least one of the brake discs 32′ and the at least one separator plate 34′ may be hardened so as to create an integral wear surface or have a coating deposited thereon to form the wear surface.

The brake discs 32′ and the at least on separator plate 34′ are arranged within the first chamber 30′ of the annular housing 12′ in an alternating series. The brake assembly 14′ shown includes four of the brake discs 32′ in an alternating arrangement with five of the separator plates 34′. In other embodiments, the brake assembly 14′ may include three of the brake discs 32′ in an alternating arrangement with four of the separator plates 34′. In yet other embodiments, the brake assembly 14′ may include two of the brake discs 32′ in an alternating arrangement with three of the separator plates 34′. It is understood that the brake assembly 14′ may include more or less of the brake discs 32′ and/or the separator plates 34′ than shown if desired.

As illustrated, the at least one separator plate 34′ may be keyed to the annular housing 16′ of the brake assembly. In certain embodiments, the at least one separator plate 34′ includes a plurality of protuberances (not depicted) (e.g. splines, teeth, etc.) formed on an outer circumferential surface thereof. The protuberances of the at least one separator plate 34′ may be configured to be in meshed engagement with a plurality of protuberances (not depicted) (e.g. splines, teeth, etc.) formed on an inner circumferential surface of the annular housing 16′ to militate against a rotational movement between the at least one separator plate 34′ and the annular housing 16′ while permitting an axial movement thereof.

Each of the brake discs 32′ and the at least one separator plate 34′ may include a respective one of central openings 50′, 52′. The central openings 50′, 52′ may provide a journaling function for the axle shaft. In certain embodiments, each of the brake discs 32′ includes a plurality of protuberances 54′ (e.g. splines, teeth, etc.) formed on an inner circumferential surface of the central openings 50′. The protuberances 54′ of the brake discs 32′ may be configured to be in meshed engagement with a plurality of protuberances (not depicted) (e.g. splines, teeth, etc.) formed on an outer circumferential surface of the axle shaft to militate against a rotational movement between the brake discs 32′ and the axle shaft while permitting an axial movement thereof. Additionally, the brake discs 32′ and/or the at least one separator plate 34′ may include an annular array of apertures 56′ formed therein to permit a flow of the fluid or a lubricant therethrough.

A first piston 60′ may be disposed in the first chamber 30′ adjacent the brake discs 32′ and separator plates 34′ opposite the end plate 18′. In certain embodiments, the first piston 60′ may be an annular member 62′ having a center bore 64′ configured to receive the axle shaft therethrough. As illustrated, the annular member 62′ of the first piston 60′ may include annular grooves 66a′, 66b′ formed in an outer circumferential surface thereof. The grooves 66a′, 66b′ may be formed in the outer circumferential surface on opposing sides of the first conduit 36′. Seals 68a′, 68b′ may be disposed in a respective one of the grooves 66a′, 66b′ to form a substantially fluid tight seal between the annular housing 16′ and the first piston 60′. Accordingly, a pressure in an activation cavity 69′ formed between the first piston 60′ and the annular housing 16′ may be maintained and/or increased for activation of the first piston 60′. An injection of the pressured fluid into the activation cavity 69′ causes the first piston 60′ to move in a first axial direction from a disengaged first position towards the brake mechanism 33′ to an engaged second position.

A biasing mechanism 70′ may be disposed in the first piston 60′ and secured to the annular housing 16′ of the brake assembly 14′. In certain embodiments, the biasing mechanism 70′ may include a pin member 72′ fixedly attached to the web portion 29′ of the annular housing 16′ and a biasing element 74′ (e.g. a helical spring) interposed between the pin member 72′ and a portion of the first piston 60′. The biasing mechanism 70′ may provide uniform biasing of the first piston 60′ causing the first piston 60′ to move in a second axial direction from the engaged second position towards the web portion 29′ of the annular housing 16′ to the disengaged first position.

When the first piston 60′ is deactivated by ceasing the flow of the pressurized fluid to the activation cavity 69′, the first piston 60′ is in the first position and the brake mechanism 33′ is thereby disengaged having the brake discs 32′ and the at least one separator plate 34′ in an expanded state. In the expanded state, the brake discs 34′ in meshed engagement with the axle shaft are permitted to rotate within the brake assembly 14′ and the axle assembly to be driven. On the contrary, when the first piston 60′ is activated by supplying the flow of the pressurized fluid to the activation cavity 69′, the first piston 60′ is caused to be in the second position and the brake mechanism 33′ is thereby engaged having the brake discs 32′ and the at least one separator plate 34′ in a compressed state. In the compressed state, frictional forces between the brake discs 34′ and the at least one separator plate 34′ causes a rotation of the brake discs 32′ and the axle shaft in meshed engagement therewith to cease and the axle assembly to be stopped.

In certain embodiments, the first piston 60′ may further include a valve 76′ disposed through a bore 78′ into the annular housing 16′ of the brake assembly 14′. In certain embodiments, the valve 76′ may include a housing 80′ disposed in the bore 78′ and a pin member 81′ disposed through the housing 80′ into the web portion 29′ of the annular housing 16′ of the brake assembly 14′. The valve 76′ may provide a relief passageway for the fluid and/or lubricant located between the first piston 60′ and the web portion 29′ of the annular housing 16′ when the first piston 60′ moves in the second axial direction from the engaged second position back to the disengaged first position.

From the foregoing description, one ordinarily skilled in the art can easily ascertain the essential characteristics of the subject matter of the embodiments described herein and, without departing from the spirit and scope thereof, can make various changes and modifications to the embodiments to adapt them to various usages and conditions.

What is claimed is:

1. A brake assembly for an axle assembly, comprising:
a brake mechanism including a plurality of brake discs;
at least one biasing mechanism including at least one biasing element disposed adjacent the brake mechanism, wherein the at least one biasing element is pre-compressed; and
a housing circumferentially enclosing at least a portion of the brake mechanism and at least a portion of the at least one biasing mechanism, wherein the housing is configured to mate with an axle housing of the axle assembly.

2. The brake assembly of claim 1, wherein the brake mechanism is an interchangeable brake mechanism, and wherein a profile of the housing is configured to receive the interchangeable brake mechanism.

3. The brake assembly of claim 1, wherein a profile of the housing is configured to receive differing numbers of the brake discs.

4. The brake assembly of claim 1, wherein further comprising an end plate configured to be coupled to the housing of the brake assembly.

5. The brake assembly of claim 4, wherein the end plate is configured to be coupled to the axle housing of the axle assembly.

6. The brake assembly of claim 1, wherein an interior cavity of the housing is divided into a first chamber and a second chamber by a web portion.

7. The brake assembly of claim 1, further comprising a first piston disposed in a first chamber of the housing and a second piston disposed in a second chamber of the housing.

8. The brake assembly of claim 7, wherein an activation of the first piston causes an activation of the brake assembly.

9. The brake assembly of claim 7, wherein an activation of the second piston causes the at least one biasing element of the biasing mechanism to move to a compressed state.

10. The brake assembly of claim 7, wherein a deactivation of the second piston results in the at least one biasing element of the biasing mechanism to move to an expanded state.

11. The brake assembly of claim 1, wherein the biasing mechanism further includes a positioning element configured to maintain a position of the at least one biasing element, and wherein a portion of the positioning element surrounds an outer circumferential surface of the at least one biasing element.

12. The brake assembly of claim 11, wherein the biasing mechanism further includes a retainer configured to maintain a position of the positioning element.

13. An axle assembly, comprising:
an axle housing; and
a brake assembly coupled to the axle housing, the brake assembly comprising:
a housing having a first chamber and a second chamber;
a brake mechanism disposed in the first chamber;
a first piston disposed in the first chamber, wherein the first piston is configured to selectively activate the brake mechanism; and
a second piston disposed in the second chamber adjacent a biasing mechanism having at least one biasing element, wherein the second piston is configured to selectively activate the brake mechanism.

14. The axle assembly of claim 13, wherein the brake assembly is removably received in and releasably coupled to an end of the axle housing.

15. The axle assembly of claim 13, wherein the brake assembly is a cartridge style brake assembly that is preassembled prior to installation into the axle assembly.

16. The axle assembly of claim 13, wherein the at least one biasing element is pre-compressed.

17. The axle assembly of claim 13, wherein the brake assembly further includes a biasing mechanism disposed adjacent the brake mechanism in the first chamber.

18. The axle assembly of claim 13, wherein at least one of the first chamber and second chamber includes an activation cavity in fluid communication with a source of pressurized fluid.

19. An axle assembly, comprising:
an axle housing configured to receive an interchangeable brake assembly, wherein the interchangeable brake assembly comprises:
a housing having at least one chamber formed therein;
a brake mechanism disposed in the at least one chamber; and
at least one piston disposed in the at least one chamber, wherein the at least one piston is configured to selectively activate the brake mechanism.

20. The axle assembly of claim 19, wherein the brake mechanism is an interchangeable brake mechanism.
